(19) United States
(12) Patent Application Publication
(10) Pub. No.: US 2008/0189364 A1
(43) Pub. Date: Aug. 7, 2008

(54) Method Of Updating Information In An Electronic Note

(75) Inventors: Ilene Landon, Vienna, VA (US); John Schillaci, Frederick, MD (US); Nigel Simmons, Potomac, MD (US)

Correspondence Address: SUGHRUE MION, PLLC, 2100 PENNSYLVANIA AVENUE, N.W., SUITE 800, WASHINGTON, DC, 20037, US

(73) Assignee: AYMAN LLC, BETHESDA MARYLAND (MD)

(21) Appl. No.: 11/571,217

(22) PCT Filed: Jun. 23, 2005
(86) PCT No.: PCT/US2005/022168

§ 371 Date: Jan. 10, 2008

Related U.S. Application Data
(60) Provisional application No. 60/581,720, filed on Jun. 23, 2004.

(51) Int. Cl. G06F 15/16

(52) U.S. Cl. 709/204

(57) ABSTRACT

A creator provides to one or more recipients an electronic note for display at the recipient's device(s). If the creator updates information in the notes the note displayed at each the recipient is automatically updated. The electronic note can have an expiration time associated with it that causes the note to expire automatically at the expiration time.

The creator can alter the expiration time after the note has been provided to the recipients. The creator and recipients can exchange and update the note based on an agreement between them. Such an agreement can be embodied in an electronic contract that specifies the information in the electronic note the creator can update.

### CROSS REFERENCE TO RELATED APPLICATIONS

The present application claims priority from U.S. Provisional Patent Application No. 60/581,720, titled “Method of Updating Information in Electronic Notes,” which is hereby incorporated by reference.

### BACKGROUND OF THE INVENTION

1. Field of the Invention

The invention generally relates to computer networking. More particularly, it relates to a method of creating electronic notes and selectively sharing such electronic notes with others over a computer and/or telephone network. If a creator of an electronic note changes the information contained in the electronic note which was previously shared with others, then a receiver's view of that note is automatically updated to reflect the creator's changes. Thus control of the note content, including its deletion, is retained by the creator, which is in contrast to other conventional messaging systems wherein both the message and its contents are delivered to and in the control of the receiver.

2. Description of the Related Art

Social groups, e.g., sports teams, book clubs and co-workers, exist in all facets of life. Members of these social groups often have difficulty communicating effectively within the group. Electronic mail (“e-mail”) allows for communications among members of social groups, but the information contained therein is often out-of-date soon after it is sent, and obsolete messages remain in the recipient's inbox until the recipient deletes them. If a sender of an e-mail needs to change or update a previously sent e-mail, the sender must send a new e-mail, which, due to the multiple e-mails existing in the inboxes of the e-mail recipients, can be confusing and cumbersome. Short Message Service (“SMS”) provides capabilities on a mobile telephone to relay messages, but the messages are often out-of-date when received and are not automatically updated or deleted when no longer valid. Calendar programs require events, such as meetings, to have start and end dates, and as such also suffer from the problems similar to those encountered with SMS and e-mail messages. For example, notices of meetings containing the meeting's start and end times and location are often sent by e-mail. If the start time, for example, changes, the meeting organizer most likely will send another e-mail message informing the meeting participants of the new start time. This leads to multiple e-mail messages that can clutter a recipient's inbox and create confusion as to which e-mail message has the most up-to-date information. In addition, these methods of communication, e-mail in particular, are subject to receiving unsolicited communications from unknown creators, commonly known as “spam”, which, in addition to being bothersome, may cause a recipient to miss important communications.

At least one software package, STICKYNOTE™ by Tenebril, Inc., allows for sharing “stickynotes” via a desktop browser. However, even with that package, there remains a need for the creator of an electronic note to retain control over the electronic note, to allow for, e.g., automatic updating, expiration and deletion of the electronic note on a desktop browser, on a mobile telephone, or other electronic device.

Current methods allowing communications between members of a group include using: (1) messages that can be updated or changed only by sending another message, thereby creating multiple messages relating to the same event, and (2) messages that are not deleted from a recipient's inbox until the recipient chooses to delete them, thereby creating clutter and confusion in the recipient's inbox.

As such, there is a need to provide a method through which members of a group can more effectively and efficiently communicate with each other.

### BRIEF DESCRIPTION OF THE DRAWINGS

Embodiments of the invention are described below in detail with reference to the following drawings, in which like reference numerals refer to like elements, wherein:

FIG. 1 is a physical representation of an embodiment of the computer and mobile phone environment in which the disclosed methods can operate.

FIG. 2 illustrates three scenarios for providing and receiving an electronic note using the disclosed methods.

FIG. 3 is a flowchart illustrating an overview of the methods disclosed herein.

FIG. 4 is a flowchart illustrating the process of a creator providing an electronic note to a recipient.

FIG. 5A is a ladder diagram illustrating the process for a creator providing an electronic note to a receiver or updating an electronic note previously provided to a receiver according to the methods described herein when a contract is already in place between the creator and the receiver in a high-speed computer networking environment.

FIG. 5B is a ladder diagram illustrating the process for a creator providing an electronic note to a receiver or updating an electronic note previously provided to a receiver according to the methods described herein when a contract is already in place between the creator and the receiver in the mobile telephone environment.

FIG. 6 is a ladder diagram illustrating steps for a creator providing a new note to a receiver according to methods here, when a contract is not yet in place between the creator and the receiver in the mobile telephone environment.

FIG. 7 is a ladder diagram illustrating steps for causing the expiration of an electronic note previously provided by a creator to a receiver in the mobile telephone environment.

FIG. 8 illustrates menu choices for selecting a process to perform, i.e., creating a new note, viewing the creator's inbox, or viewing sent notes, and setting the creator's preferences and creating templates.

FIGS. 9A-B illustrates steps for creating a new note.

FIG. 10 illustrates steps for controlling the creator's inbox.

FIG. 11 illustrates steps for editing or updating a previously sent note.

FIG. 12 illustrates an example of an interface showing information displayed in an electronic note received in mobile telephone environment.

FIGS. 13A-13E illustrate examples of various skins for an electronic note.

### SUMMARY OF THE INVENTION

Methods and systems are described here for sharing and updating information between a creator and one or more receivers in which the receivers comprise a group formed from the creator's social contacts. The creator and the receivers each have a digital identity, and the creator has a list of the receivers' digital identities. The method includes specifying information to be shared with the receivers, specifying the identities of the receivers, and providing the information for display to the receivers. The information provided to each receiver is provided based on a contractual relationship between the creator and each receiver. If at least some of the information previously provided to the receivers is changed, that changed information is automatically provided to the receivers based on the contractual relationship. The information and/or the changed information are associated with an expiration time so that original information in the note and/or the changed information displayed at the receivers automatically expires at the expiration time.

### DETAILED DESCRIPTION OF EXEMPLARY EMBODIMENTS

Disclosed herein are methods that allow a first entity (a creator) to provide electronic notes to a second entity's (a recipient's) communication device, such as a mobile telephone, personal computer or personal digital assistant (PDA). Unlike with e-mail or instant messaging, the methods disclosed herein allow the creator to retain control of the electronic note to automatically update previously sent electronic notes. Thus, the recipient's are provided, for a limited time, a view of the note. In certain embodiments, the note creator can assign control of a note to another party. This would allow, for example, an electronic note's creator to assign control of the note to, for example, the creator's assistant to allow the assistant to update the note as necessary. The updated electronic notes are pushed to the recipient and replace the out-of-date previously sent electronic note. However, in some environments, for example, in a high-speed network, it is possible that the notes are not pushed, but are viewed only when a recipient chooses to view the note. The electronic notes are atomic (i.e., unitary) items of content that may comprise text, graphics, and associated layout of the same according to some style and can be presented to appear as, for example, a self-stick note as, for example, a POST-IT NOTE.™ In addition, the electronic note could be an audio or video file.

In addition, the methods disclosed herein allow the creator to associate an expiration time with an electronic note. Upon passage of the expiration time, the electronic note is automatically deleted from the recipient's communication device, making it easier for the recipient to stay up-to-date on activities and to manage the information flowing into the recipient's mobile telephone, personal computer or PDA or other type of communication device. Additionally, the exchange of electronic notes according to the methods described herein can be governed based on the creator's and/or receiver's network of social contacts. The disclosed methods can create an environment in which a recipient receives electronic notes only from those creators with whom the recipient has entered into an agreement or contract with to exchange messages, thus substantially reducing the likelihood of unwanted or unsolicited messages, often referred to as spam, and preserving the recipient's privacy. This contract is a private agreement, i.e., the agreement is to limit why may access the note and limiting disclosure of who has access to the note, such that the control of the note and the recipients of the note are private.

The exchange of electronic notes using techniques described here can form a permission-governed exchange of data that flows based on trusted relationships that are established between entities. An underlying identity server can be used as an update mechanism to push changes in an electronic note's content and attributes to the electronic note's recipients.

The techniques described herein build on social relationships supported by electronic contracts described in U.S. Provisional Patent Application 60/487,191, titled “Social Network of Identities and Query Method Therefor,” which is hereby incorporated by reference.

### Infrastructure

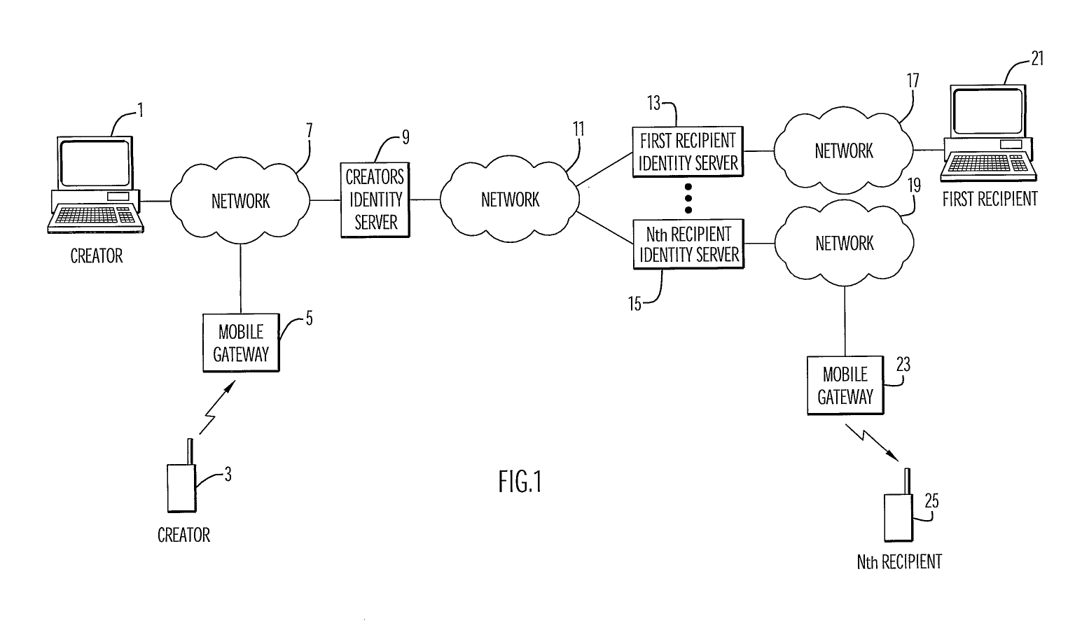

FIG. 1 shows a physical representation of one embodiment of a computer and mobile telephone environment in which the methods disclosed herein can operate. In FIG. 1, a creator's computer 1 is connected to network 7. Network 7, which can be any type of communication network, such as a wide area network (WAN) or local area network (LAN), is connected to an identity server 9 associated with the creator and which is connected to another network 11. Network 11, which, like network 7, can be any type of communication network, is connected to a plurality of recipient identity servers 13 to 15. A first recipient identity server 13 is connected to yet another network 17, which is connected to computer 21 used by a first recipient. An nth recipient identity server 15 is connected to still another network 19, which is connected to a mobile gateway 23. Mobile gateway 23 communicates with mobile telephone 25 of an nth recipient. Similarly, a creator has a mobile telephone 3 which communicates with a mobile gateway 5, which is connected to network 7 as illustrated in FIG. 1. From network 7, creator 3 is communicably connected to the computer 21 of a first recipient and the mobile telephone 25 of the nth recipient by the infrastructure shown in FIG. 1 and described above.

Identity servers 9, 13 and 15 may contain a plurality of identity accounts (not shown), each of which is associated with a unique entity. For example, an identity account resident on creator's identity server 9 can be associated with the creator. These identity accounts contain, inter alia, electronic contracts that govern the exchange of electronic notes.

An example of the identity server that can be used as identity servers 9, 13 and 15 is the Trusted Data Exchange™ (TDX) server by EPOK, Inc. of Bethesda, Md.

### Basic Scenarios

The methods disclosed herein relate to the providing and receiving of electronic notes between at least two entities, a creator and a receiver. However, to protect a receiver's privacy and to avoid problems associated with spam, the exchange of electronic notes between entities can be regulated by agreements between the creators and receivers to keep the electronic notes updated. One way of handling such agreements is to use electronic contracts, such as described in U.S. Patent Application No. 60/487,191, titled “Social Network of Identities and Query Method Therefor.” The methods described herein can be governed by such electronic contracts that can exist between the entities, although it will be understood that other techniques that facilitate agreements between a creator and a receiver can be used. These electronic contracts, which may reside in an identity account associated with an entity, govern the exchange of information between a creator and a receiver. In particular, these electronic contracts can control the exchange of electronic notes between two entities. These electronic contracts ensure that a receiver will only receive electronic notes from those entities with which the receiver has an electronic contract governing the exchange of electronic notes.

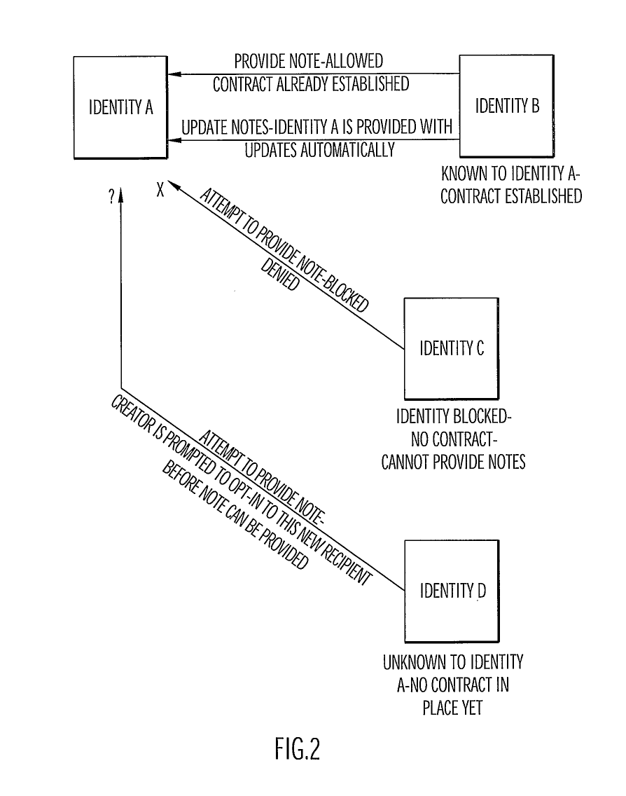

FIG. 2 shows three relationships that can exist between entities which may wish to exchange electronic notes. In this example, each entity is represented by a digital identity that is unique among entities communicating with one another. In FIG. 2, identities B, C and D are shown attempting to provide an electronic note to identity A. Identity A and identity B have a contract in place for sharing information. Thus, when identity B attempts to provide identity A an electronic note, because an electronic contract is in place between those identities that permits identity B to send an electronic note to identity A, the electronic note is sent to identity A. If the contract permits identity B to update the note, then any updates to the electronic note that identity B makes to the note are reflected in the note previously received by identity A.

Identity C is “blocked” by identity A, either by an express condition in an electronic contract between identity A and identity C or because no electronic contract exists between identity A and identity C. Accordingly, if identity C tries to provide an electronic note to identity A, the electronic note is blocked so that identity A does not receive the electronic note. Thus a receiver can prevent receipt of electronic notes from select parties.

Identity D is unknown to identity A and thus no electronic contract exists between identity A and identity D. Identity D has not, however, been blocked by identity A because no contract exists between them. When identity D attempts to provide an electronic note to identity A, identity A can be given the option of entering into an electronic contract with identity D before the electronic note is accepted by identity A. If an electronic contract is so established, identity A will receive the electronic note. If identity A refuses to establish a contract with identity D, the electronic note will not be received. Further, identity A has the option of blocking any future electronic notes from identity D if identity A so desires.

### Overview of Creation, Update and Expiration of an Electronic Note

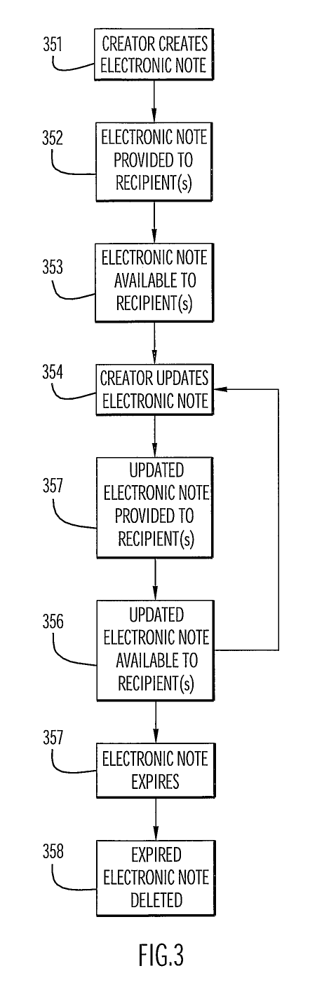

An overview of the steps associated with the methods disclosed herein will now be described with reference to FIG. 3, which is a flowchart illustrating the steps of the methods disclosed herein. In step 351, a creator creates an electronic note by accessing a client application. The electronic note is provided to one or more recipients at step 352. At step 353, the electronic note becomes available for display to the recipients, if contractual relationships so permit, and, if permission is granted by the creator, the recipients can see the identities of others to whom the creator provided the electronic note.

At step 354, a previously provided electronic note can be updated by the creator providing updates to the note to one or more of the recipients. After such updates are made to the note, the updated electronic note is made available for display to the recipients at step 356. The electronic note displayed to the recipients is automatically updated to reflect the change made by the creator. Electronic notes may be updated as often as necessary.

Steps 357 and 358 show the process of causing an electronic note to expire. When the creator creates or updates an electronic note, the creator can specify an expiration time for the electronic note. Upon passage of this expiration time at step 357, the electronic note is automatically deleted from the recipient's communication device (e.g., a computer, PDA or cell phone) at step 358.

### Process of Providing a Note

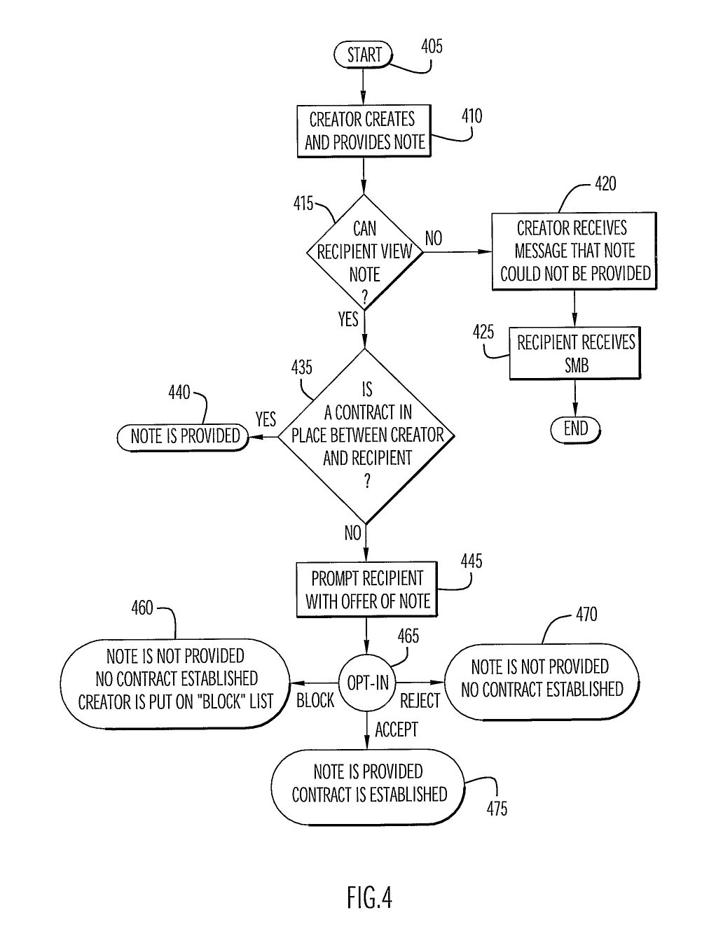

FIG. 4 is a flowchart illustrating the steps of a creator providing an electronic note to a recipient. First, at step 405, the creator starts the process of providing a note by accessing a client application on a creator's communication device, such as the creator's computer 1 or mobile telephone 3, and choosing to create a new electronic note. At step 410, the creator creates and sends an electronic note to a recipient. At step 415, it is determined if the recipient can view the electronic note. The recipient will be unable to view the provided note if the recipient's communication device, e.g., phone, PDA or computer, does not have the capability or appropriate software installed to view the note. If the recipient is unable to view the electronic note, the creator receives a message indicating that the electronic note could note be sent (step 420). Then, at step 425, the recipient is sent an SMS message containing the unformatted text of the electronic note, since it is likely that the device has the capability to receive and display simple SMS messages.

If at step 415 it is determined that the recipient can view the electronic note, it is next determined at step 435 if there is an electronic contract in place between the creator and the recipient. If there is a contract in place, and the contract so permits, the electronic note is provided at step 440. However, if it is determined at step 435 that no contract is in place, the recipient is, at step 445, prompted with an offer for exchanging the electronic note, i.e., the recipient is notified that a creator, with whom the recipient does not yet have a contract, has provided the recipient an electronic note. The recipient then, at step 465, may choose to accept, block or reject the electronic note. If the recipient blocks the electronic note, as shown at step 460, the electronic note is not provided to the recipient, no contract is established and the creator is put on a block list so that any future note from the creator will not result in a prompt at step 445. If the user accepts the electronic note, at step 475 a contract is established between the creator and the receiver and the electronic note is provided. If the creator rejects the electronic note, at step 470 the electronic note is not provided and no contract is established. However, the creator will not be placed on a block list.

Providing an Electronic Note or Updated Contents to a Recipient who has Blocked Electronic Notes from the Creator

As shown in FIG. 4, in the methods disclosed herein, users will not receive messages from unknown entities. Notes provided by unknown entities (identities with whom user does not know has not already had contract) are sent as offers to the recipient as illustrated in FIGS. 2 and 4. The recipient can accept the new note and establish a contract or block the note and add the creator to a block list. Thus, recipients can only receive notes from those identities with whom the recipient has opted-in to viewing. The flowcharts shown in FIGS. 2 and 4 illustrate this concept.

For example, for parents and children, it is possible to use a “white list” approach where an opt-in list is established. Any creator not on the parentally-approved opt-in list is automatically blocked, instead of presenting the child with an offer as described above. Thus, the parent can control with whom the child communicates. The parent can, in one embodiment, receive the opt-in offer and to choose whether or not to allow the child to communicate with that particular creator.

While FIG. 4 illustrates an opt-in embodiment for contract-governed electronic notes, alternatively, an opt-out embodiment can be used. In an opt-out embodiment, electronic notes are provided to and received by recipients unless the receiver has blocked the creator. This allows the user to receive notes from all users who have not been specifically blocked.

Providing an Electronic Note or Updated Electronic Note to a Recipient with which the Creator has an Electronic Contract

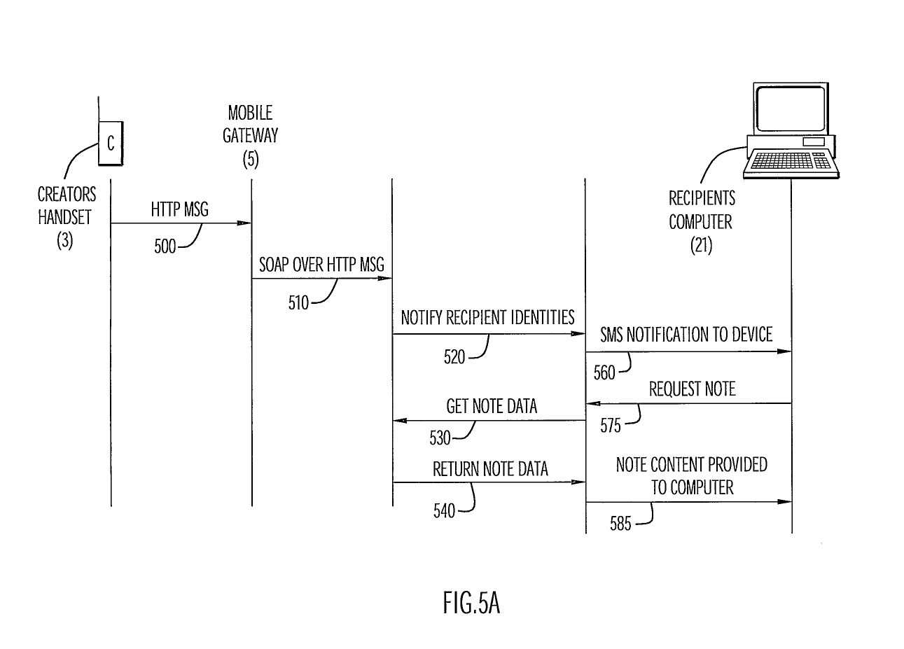

A process for a creator providing a note to a recipient will now be described with reference to FIG. 5A. FIG. 5A is a ladder diagram graphically illustrating the steps for a creator providing and/or updating an electronic note disclosed herein when an electronic contract is in place between a creator and a receiver to permit automatic update of electronic notes and the recipient is able to view the note. While this example describes the method in a high-speed computer networking environment, the methods disclosed herein are not so limited, and can be employed in a variety of environments, including in a mobile telephone environment, such as shown in FIG. 5B.

As shown in FIG. 5A, a creator first creates an electronic note by employing the later described client application resident on the creator's handset 3 shown in FIG. 1. The client application resident on the creator's handset may typically use HyperText Transmission Protocol (HTTP), or equivalent protocols provided by a mobile operating authority, for communication between the handset and network-based servers. After creating the electronic note, the note is provided to a recipient as discussed below.

Referring to FIGS. 1 and 5A, first, at step 500, the electronic note is transmitted by way of HyperText Markup Language (HTML) over HTTP protocol, to a mobile gateway 5, which is configured to receive HTTP messages from mobile telephones such as creator's handset 3. Other languages equivalent to HTML may be employed. The HTTP message contains, for example, the recipient's unique identity identifier, the electronic note's contents, the electronic note expiry date and time, and one or more indicators of attributes for the electronic notes, e.g., the skin to be applied to the electronic note upon display to the recipient. Upon receiving the HTTP message, mobile gateway 5 formats and forwards the information to creator's identity server 9 at step 510. The latter is achieved using the efficient client-server messaging protocol of Simple Object Access Protocol (SOAP) over HTTP as the Application Programming Interface (API) of the creator's identity server. Other equivalent client-server protocols may be used.

Creator's identity server 9 recognizes the recipient's identity and determines that the recipient's identity corresponds to recipient's identity server 15. Creator's identity server 9 then notifies recipient's identity server 15 that a new or updated electronic is available at step 520. This notification can include, for example, a pointer, such as an address, to the electronic note. Creator's identity server 15 then notifies a recipient's computer 21 that a new or updated note is available at step 560. Computer 21 can then employ any number of known alerting techniques (e.g., sounds or icons appearing on a screen) to let the computer's user know that such a notification has been received. The notification to recipients' computer 21 can be, for example, an SMS message. Upon receipt of the notification, a recipient can then choose to view the electronic note by requesting the note at step 575. Upon receipt of the request at step 575, recipient identity server 15 performs a get note data step 530 wherein the recipient identity server 15 requests, using SOAP over HTTP, the new or updated note referenced in the notification message sent at step 520. The creator's identity server 9 then responds with the note information to recipient's identity server 15 at step 540. The electronic note information is then returned to computer 21 (step 585). While viewing the electronic note, the note resides on creator's identity server 9. A recipient is provided only with access to the current note, such access being, in one embodiment, view access while the creator retains control of the note.

In certain embodiments, the recipient of an electronic note may, if permitted by the creator of the electronic note respond to the note. Such responses may be multiple-choice responses set by the creator, e.g., reserve, confirm, cancel, or revise, or they may be more free-form responses that allow the recipient to send unique responses. Once a response is sent, it is routed back to creator's identity server and stored at the server with the electronic note. One example of such a response is a response to an electronic note notifying its recipients of a meeting. The recipients could then respond to the electronic note from one of three multiple-choice options set by the creator such as: (A) Will attend, (B) Will not attend, (C) Undecided, thereby notifying the creator who will be at the meeting. If so permitted, the creator can allow recipients' responses to be viewed by other recipients. In such an embodiment, responses would be sent as updates to an electronic note.

For slower communications networks, for example, a mobile phone network, it may be desirable to request electronic note data to be provided to a recipient's communication device prior to notifying the recipient that new or updated electronic. Thus, an electronic note may be cached on a recipient's device, which allows a recipient to view an electronic note immediately without waiting for the note to be provided over the network. One example of such a method is shown in a mobile phone environment in FIG. 5B.

In FIG. 5B, steps 500, 510 and 520 are as described above with respect to FIG. 5A. However, in FIG. 5B, upon receipt of the notification at step 520, recipient's identity server 15 initiates the note update process at step 525. In the note update process, recipient identity server 15 performs a get note data step 530 wherein the recipient identity server 15 requests, using SOAP over HTTP, the new or updated note referenced in the notification message sent at step 520. The creator's identity server 9 then responds with the note information to recipient's identity server 15 at step 540.

Upon receipt of the note information, recipient's identity server 15 at step 560 sends a SMS notification message to recipient's handset 25 notifying the recipient that an electronic note is cached on recipient's identity server 15. The SMS message is formatted so that it is capable of being trapped by an application on the recipient's handset, registered for this type of message, rather than being directed to the recipient's SMS message inbox. Thus the recipient is not aware of the receipt of the SMS notification message. The SMS notification message is sent using SMS sending facilities provided by the mobile telephone operating authority.

To enhance the recipient's experience and to avoid the user having to wait while the electronic note data is retrieved to the recipient's handset 25, the electronic note data can be pre-fetched. When the SMS notification is sent to the handset 25 indicating new electronic notes are available at step 560, the notification is intercepted by an application program resident on handset 25 (step 560). The application then requests the electronic note from recipient's identity server 15 using HTML over HTTP protocol (step 570). The electronic note information is then returned to handset 25 (step 580). The recipient may then be provided with a visual or audible notification that new or updated electronic note information is available for display. The recipient can then immediately view the electronic note cached on handset 25 without having to wait for it to be downloaded. This method has the advantage that electronic note information is available on the handset even when the handset is out of communication with the mobile network.

Upon receipt of the SMS notification message (at step 560), in one embodiment (not shown in FIG. 5), the recipient receives the SMS notification, at which time the recipient can choose to download the electronic note from recipient's identity server 15. After choosing to download the electronic note from recipient's identity server 15, an instruction is sent from handset 25 to recipient's identity server 15 instructing recipient's identity server 15 to send the electronic note data to recipient's handset 25. Upon receipt of the electronic note data, an application resident on handset 25 intercepts the electronic note data and appropriately formats the electronic note data for display to the user as an electronic note. The electronic note is then saved on handset 25 until the electronic note expires. The SMS notification sent to handset 25 can contain a variety of information, e.g., specific note identification information, name of the identity server to retrieve the electronic note from, or the SMS notification can simply provide handset 25 with notice that a new electronic note is available.

Providing an Electronic Note to a Recipient with which the Creator does not have an Established Electronic Contract

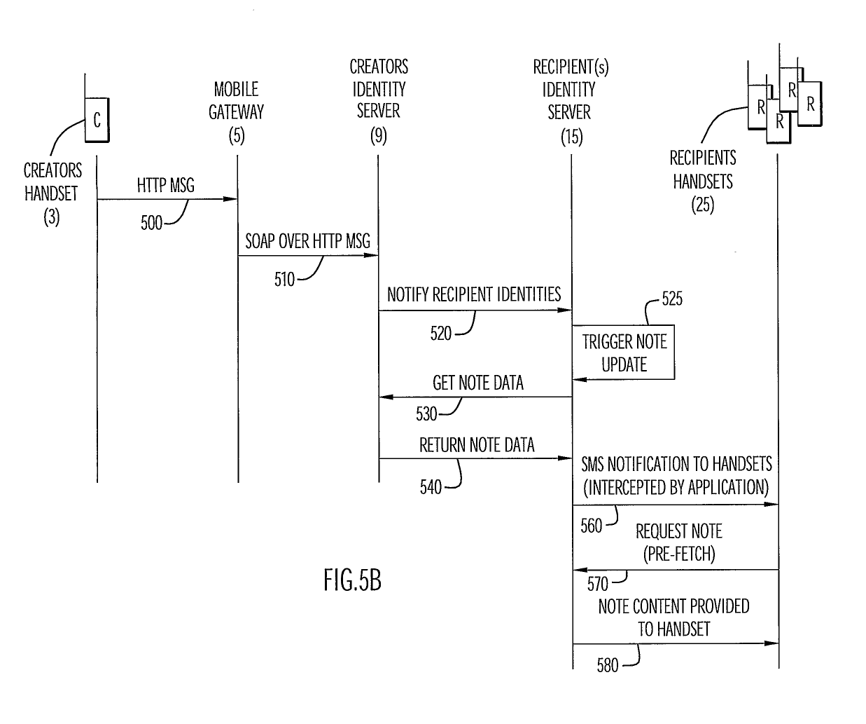

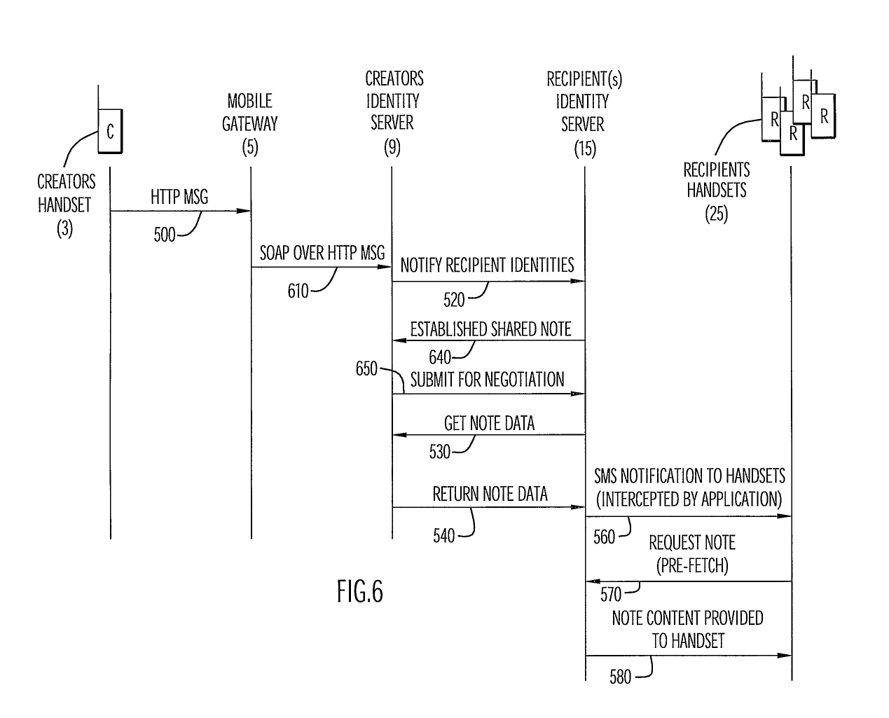

As shown in FIG. 2, it is possible that a creator may wish to provide an electronic note to a recipient with whom the creator does not have an electronic contract governing the sharing of information between the creator and the receiver. FIG. 6 is a ladder diagram that illustrates the steps for providing a new electronic note according to the methods disclosed herein when an electronic contract has not yet been established between a creator and a receiver in the mobile telephone environment.

A creator creates an electronic note that is sent from handset 3 to mobile gateway 5 as an HTTP message and then forwarded to creator's identity server 9 as discussed with respect to FIG. 5 and illustrated by steps 500 and 510. Recipient's identity server 15 is then notified that an electronic note is stored on creator's identity server 9 at step 520.

Upon receipt of the notification at step 520, recipients' identity server 15 compares the creator's identity with a list of identities with which the recipient has established electronic contracts governing the sharing of data. These electronic contracts may be stored in the recipient's identity account resident on recipient's identity server 15. If it is determined that a contract exists, the steps as described with respect to FIG. 5 are followed. However, if it determined that a contract does not exist, the identity account resident on identity account server 15 will, at step 640, seek to establish access to the note by sending a message to creator's identity server 9 seeking first to create an electronic contract. If conditions, as may be identified by the creator, for entering into a new contract are met, an electronic contract is submitted for negotiation at step 650. If the contract proposed by creator's identity account 9 is satisfactory at recipient's identity server 15, an electronic contract is created (step 560) and the identity account resident on identity server 15 requests the note data at step 530. After requesting the note data at step 530, steps 540, 560, 570, and 580 may then be followed as previously described with respect to FIG. 5.

Of course, while the steps described above generally allow for automatically entering into “default” contracts without recipient or creator intervention, it should be appreciated that it is within the scope of Applicant's invention to seek recipient or creator input prior to entering into a contract. In addition, after creation of an electronic contract, the terms of the contract can later be altered.

### Causing an Electronic Note to Expire

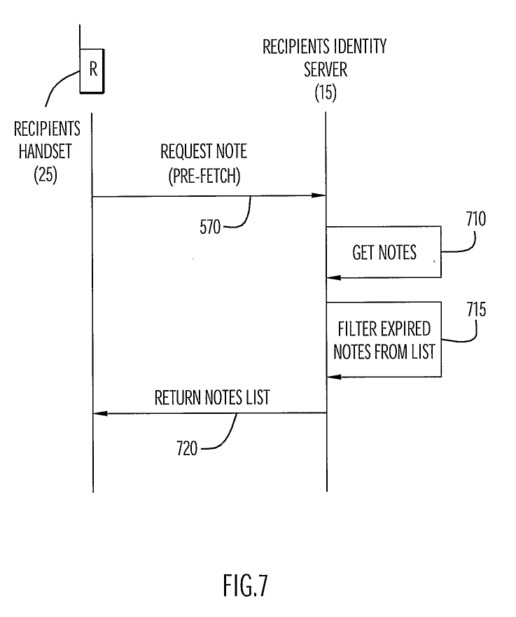

Electronic notes may contain an expiry date and time. Often this is set to some convenient boundary (e.g., 11:59 p.m. on a certain day). FIG. 7 is a ladder diagram illustrating the steps for causing the expiration of the electronic note previously provided by a creator in the mobile telephone environment. When the handset retrieves from the user's identity server (15) cache the latest allowable note set, step 570, any notes for which the current time is greater than the expiry time of the note are removed from the handset cache at step 715, whereas unexpired notes are retrieved and/or updated at step 710. The list of available, non-expired notes is then returned to handset 25 at step 720. Similarly, since the cache represents only the electronic notes that are currently available to the recipient from the creator, any note that is no longer accessible from the creator's identity server is deemed to have expired and is removed from the local cache, and not returned to the user's handset.

When the list of currently available notes is returned to the handset, any notes stored on the handset that are not in the currently available note list are automatically deleted. Any notes that are in the available note list will have their content and expiry information updated.

When accessing the note information on the user's handset, notes whose expiry time is earlier than the current time are not displayed.

### The Application Client

In one embodiment, referring to FIG. 1, an application client resides on a user's computer 1 or a user's mobile telephone 3. The application client allows a user to, among other things, create, send, and update electronic notes and cause them to expire. The application client presents the user a variety of menus that the user can use to navigate to format the application client and the content and attributes of electronic notes. The application client provides the interface to the underlying infrastructure employing the methods disclosed herein to allow the user to send, receive, and update electronic notes and cause those notes to expire.

A user implements the methods disclosed herein by accessing a client application resident on the user's communication device, such as a mobile telephone, personal computer or PDA. The client application presents to the user an interface that allows the user to enter the electronic note's contents, define the electronic note's attributes, define the electronic note's expiry time, define the electronic note's recipient list and send the note to its recipients. Further, the client application allows the user to access previously sent notes, which may be saved on the user's mobile telephone 3, personal computer 1, PDA or identity server 9. By accessing previously sent electronic notes, the user can update those electronic notes as desired.

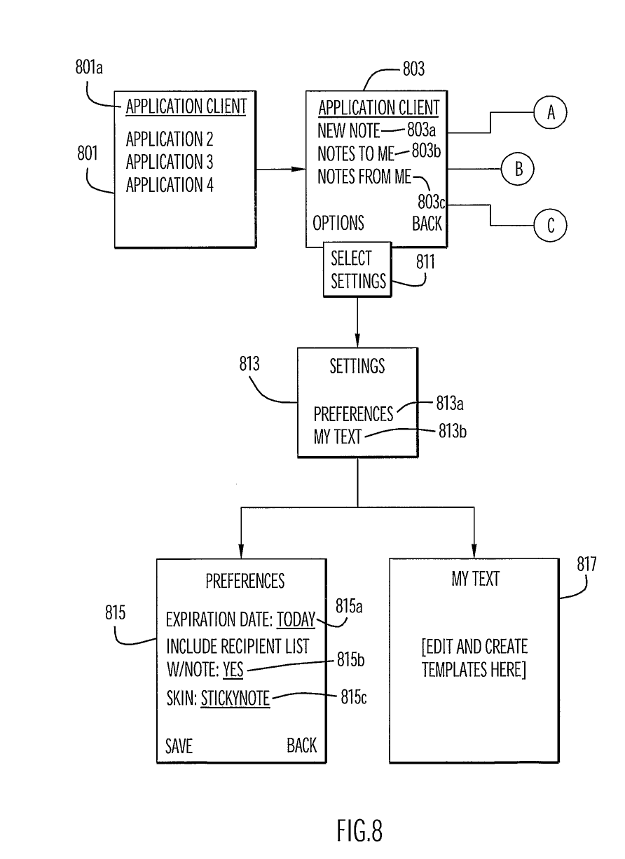

FIG. 8 illustrates one example of how the user can navigate within such an application client. First, a user opens the application client by using menu 801 by selecting the application client 801a. Of course, other application clients, such as application clients 2-4, can be shown on the menu. The user is then presented with menu 803, which allows the user to create a new electronic note by selecting the “New Note” option 803a, view electronic notes in the user's inbox by selecting the “Notes to Me” option 803b and view notes in the user's outbox by selecting the “Notes from Me” option 803c. Back, Save, and Next controls, such as those shown in menus 803 and 815, allow a user to more easily navigate the various menus. An Options menu 811 also allows a user to navigate the application client by presenting the user with sub-menus.

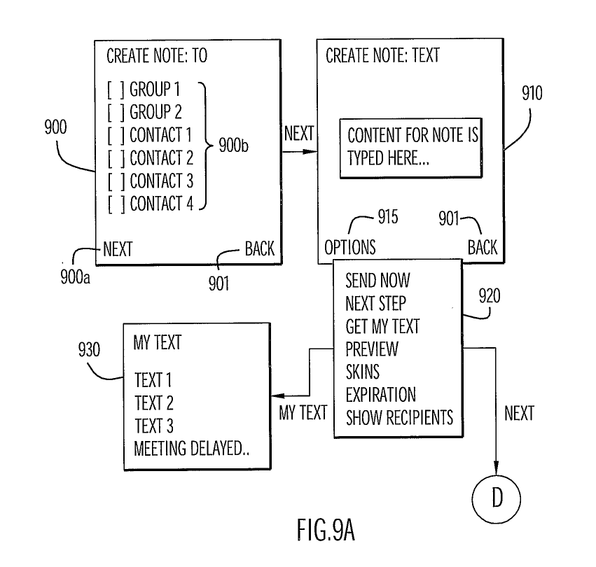

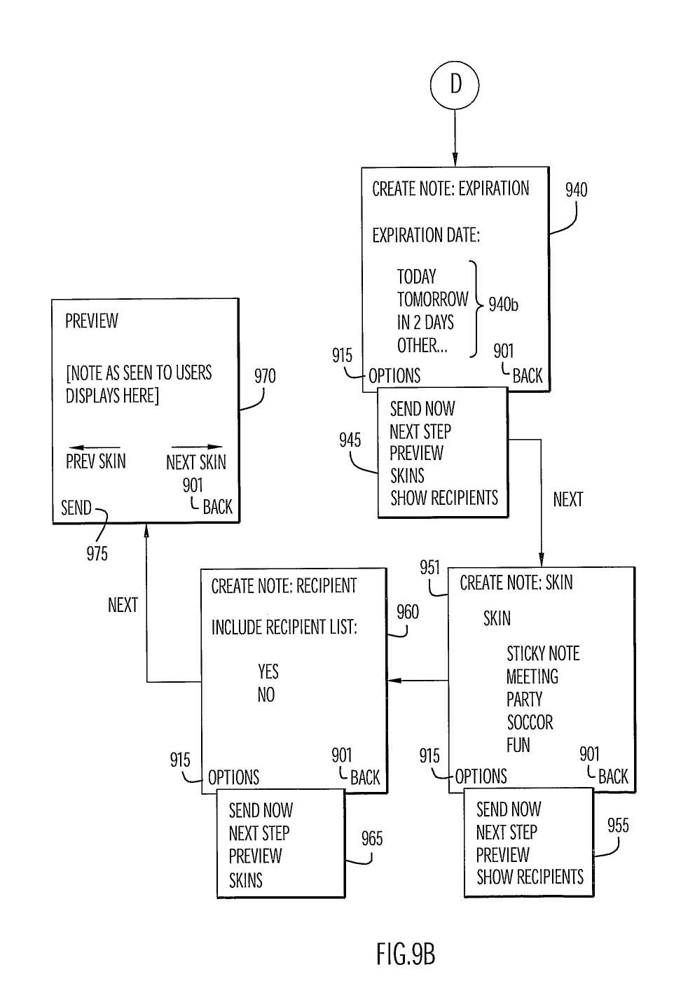

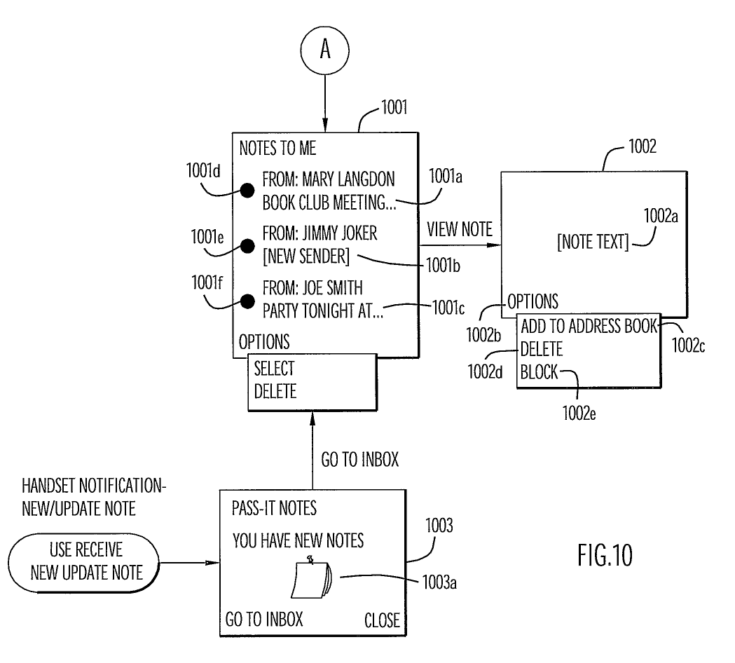

If the user chooses to create a new electronic note by selecting the “New Note” option 803a, the user is presented with the New Note interface illustrated in FIGS. 9A-B. If the user chooses to view the user's inbox, the user is presented with the Notes to Me Interface illustrated by FIG. 10. If the user chooses to view the user's outbox, the user is presented with the Notes from Me interface illustrated by FIG. 11.

While navigating application client menu 803, the user may also edit the application client's default and template options by selecting an Options control 803d. If the user chooses the Options menu from menu 803, the user is presented with a Settings menu 813, which allows the user to revise the user's default electronic note attributes by accessing a Preferences menu and to create and edit electronic note templates by selecting My Text menu.

If the user selects Preferences control 813a on settings menu 813, the user is then presented with a Preferences menu 815. Preferences menu 815 allows the user to customize the application client by setting default values that will apply to electronic notes unless changed. For example, as shown in FIG. 8, Preferences menu 815 can include options that allow the user to set a default expiration date for an electronic note 815a, options that allow a user to set a default condition allowing recipients of electronic notes to view a list of the recipients of the electronic note (recipient list 815b) and options that allow the user to set a default skin 815c for the user's electronic notes. This menu is not limited to displaying the settings information described here, but can include few or more types of information concerning a variety of different options for a user's preferences for electronic notes.

If the user selects the My Text control 813b in the Settings menu 813, the user is presented with My Text menu 817 where the user can edit and create templates, i.e., preformatted electronic notes, for use in the user's electronic notes. For example, the user can set a template as “Running Late.” The user can then send an electronic note containing the text “Running Late” with a reduced number of keystrokes by selecting the “Running Late” template. The user can create a wide array of templates to meet the user's particular needs.

### New Note Interface

If at application client menu 803 of FIG. 8, the user selects New Note option 803a, the user is presented with the application client's New Note interface shown in FIGS. 9A-B. After selecting New Note option 803a at menu 803, the user is presented with the “Create Note:To” menu 900. At menu 900, the user chooses which contacts or groups 900b the user is going to send a new electronic note to. At menu 300, the user is presented with the a checklist 300b listing the groups and contacts contained in the address book of the user's mobile telephone, personal computer or PDA. In addition, the user can enter an address for a recipient not contained in the user's address book. If the user selects a contact having multiple number's stored, the user can be presented with a menu wherein the user must select which of the numbers the user would like to send the electronic note to.

After completing the selection of recipients at menu 900, the user chooses the Next option 900a from menu 900. The user is then presented with the “Create Note: Text” menu 910. In menu 910, the user enters the text of the electronic note. Also available at menu 910 are Options menu 915 and Back menu 901. If the user chooses back menu 901, the user is sent to the immediately previous menu where the user can revise entries made in the previous menu. If the user chooses Options menu 915, the user is presented with a drop-down menu 920 containing options “Send Now,” “Next Step,” “Get My Text,” “Preview,” “Skins,” “Expiration” and “Show Recipients.” If the user selects option 920a, “Send Now,” from drop-down menu 920, the message is immediately provided to the recipient. Any note options not specifically identified by the user will be set as the default option. If the user chooses the “Next Step” option 920, the user is presented with the next menu that needs to be completed. The user can “next” their way through the new electronic note navigation shown in FIGS. 9A-B, or the user can selectively edit only those menus the user desires to edit.

If the user selections “Next Step” from the drop-down menu 920 while in menu 910, the user is presented with the “Create Note: Expiration” menu 940. At menu 940, the user sets an expiration date 940a from the electronic note. The user is presented with a list of commonly used expiration dates 940b, e.g., today, tomorrow, 2 days, and an “other” option that allows the user to set a custom expiration date.

If the user selects “Next Step” from drop-down menu 920 while in the “Create Note: Expiration” menu 940, the user is presented with the “Create Note: Skin” menu 950. In menu 950, the user can choose the skin associated with the electronic note. The user can scroll through the available skins to preview the appearance of each skin. When a recipient views the electronic note, the electronic note will be presented with this skin.

If the user selects “Next Step” from drop-down menu 920 while in “Create Note: Skin” menu 950, the user is presented with the “Create Note: Recipient” menu 960. At menu 960, the user can choose whether to allow the recipients to view the electronic note's recipient list created at menu 900. If the user selects “Next Step” from drop-down menu 920 while in “Create Note: Recipient” menu 960, the user is presented with Preview screen 970. At Preview screen 970, the user can preview how the electronic note will appear to the recipients. The user can return to previous menus to revise an attribute of the electronic note by selecting Back option 901, or can choose to send the electronic note by selecting Send option 975.

### Notes to Me Interface

Referring back to the Application Client menu 803, if a user selects the Notes to Me option 803b from application client menu 803, the user is sent to the Notes to Me interface shown in FIG. 10 where the user can access electronic notes that others have provided to the user.

When the user accesses the application client's Notes to Me interface shown in FIG. 10, the user can view the electronic notes the user has received. One such note that may be displayed in the Notes to Me menu 1001 is note 1001a. In the Notes to Me menu 1001, the user can view the creator of the electronic note and can view a portion of the electronic note. Status icons 1001d, 1001e and 1001f associated with each electronic note are displayed in the Notes to Me interface 1001. For example, icon 1001d is shown to the left of note 1001a. Icon 1001a provides a visual cue as to the status of note 1001a. For example, icon 1001d (and similarly icons 1001e and 1001f) can be color-coded, shape-coded or symbol-coded. If icons 1001d-1001f were color-coded, a green circle might represent a new, unread electronic note from a known user, whereas a yellow circle might represent an electronic note from a known recipient that has been already been read.

By selecting an electronic note, the full electronic note becomes visible at screen 1002. When viewing the full electronic note, an options menu 1002b is presented to the user. If the user chooses option menu 1002b, the recipient can add the creator of electronic note 1002 to the user's electronic address book, can delete the electronic note 1002 or can chose to block all future electronic notes from the creator of the electronic note 1002.

In one embodiment, an icon can be displayed on the user's mobile telephone, PDA or personal computer indicating that new or updated notes are available. For example, in a mobile telephone application, an icon 1003a can indicate to a user that new or updated notes are available.

Notes from Me Interface

If at application client menu 803 in FIG. 8, a user chooses to Notes From Me option 803c, the user is presented with Notes From Me menu 1101 shown in FIG. 11. Notes From Me menu 1101 is similar to a sent items folder used in many e-mail accounts in that the user, i.e., the creator, can access notes previously sent by the user. By the creator selecting a note in the Notes From Me menu 1101, the note is opened and displayed for editing 1105. Here, the creator can update the contents of a previously sent electronic note or change one of its attributes, e.g., the expiration time associated with the note. When finished changing the note, the creator can selected the “Send Now” function to send the updates to the receiver(s).

### Interface at Receiver

Upon receipt of an electronic note to view, the electronic note is presented to the user. In one embodiment, the user is presented with a display 1210 showing the user 1210a, the electronic note contents, 1210b, a drop-down options menu 1210c, a close menu 1210d and a status icon 1210e. While not shown in FIG. 12, the electronic note will be displayed to the user as having a skin as selected by the user. Status icon 1210e provides the user a visual representation of the status of the electronic note. For example, if the electronic note has been updated since last read by the user, the status icon can be a red circle. A wide variety of other conditions can also be indicated.

By selecting drop down menu 1210c, the user can view the electronic note details 1210f, add the user of the electronic note to the user's address book 1210g, delete the electronic note 1210h, reply to all the recipients of the electronic note and the electronic notes user 1210i or reply to only the electronic note's user 1210j. If the user chooses the view details option 1210f, the user is presented with display 1220. Display 1220 displays to the user the expiration date of the electronic note 1220a, the electronic note's recipient list 1220b, if appropriate, and the number of times the electronic note has been updated 1220c.

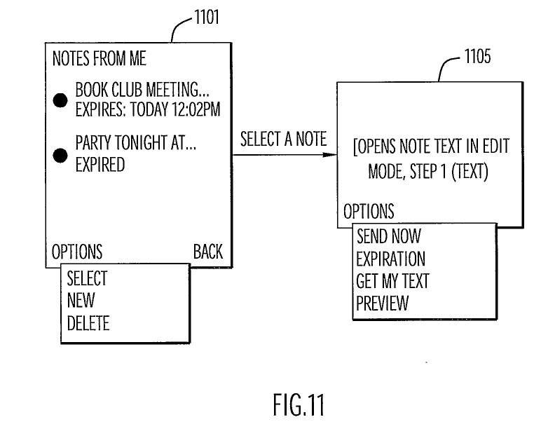

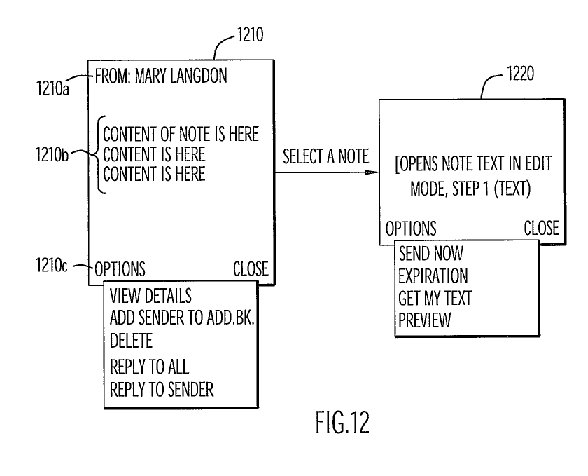

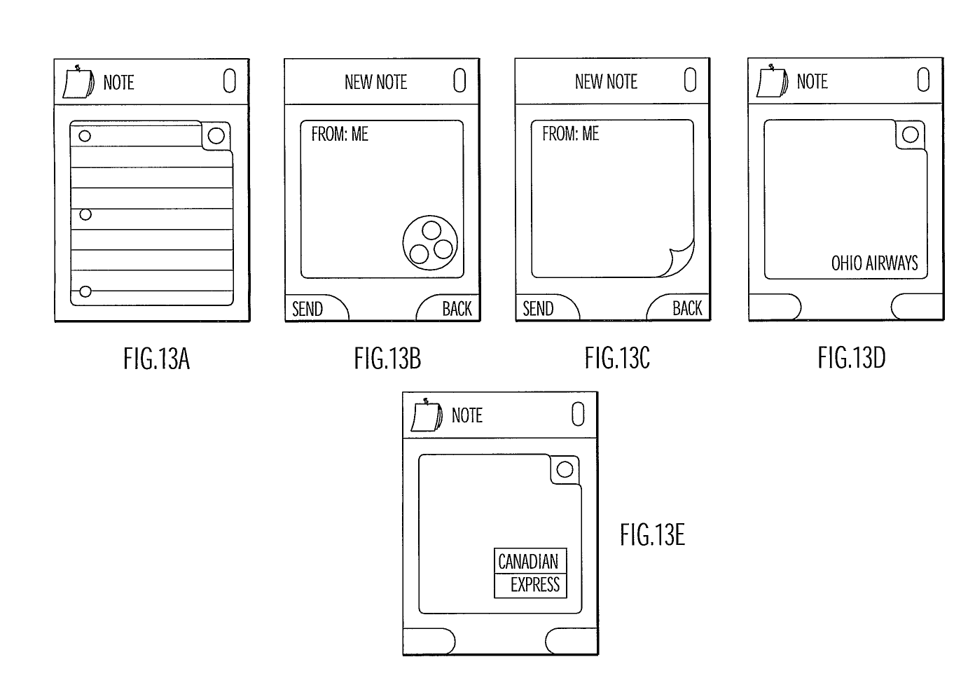

The methods disclosed herein allow for delivery of electronic note content in a rich media environment through the use of a variety of “skins.” These skins enhance the user's experience. Examples of these skins are shown in FIGS. 13A-13E. The electronic note shown in FIG. 13A is shown with the “notebook” skin, which is only one of a number of possible skins. FIG. 13C shows an electronic note with a sticky note skin. The electronic notes shown in FIGS. 13A-13E contain no text, however, a variety of text could be shown based upon the user's input. A soccer coach could provide an electronic note to her team about a schedule change for a soccer game and use a soccer-themed skin. See FIG. 13B. An electronic note provided from an airline containing, for example, updated flight times and departure gates, might include as part of its skin the airline's logo and aviation-related images. See FIG. 13C. Select merchants with whom a user has an established relationship can provide that user information regarding specials. The electronic note's skin can contain an image with the merchant's logo, or may contain a bar code that can be scanned for discounts on merchandise. See FIG. 123.

Techniques described in U.S. patent application Ser. No. 10/873,450 titled “Presentation of Information Based On Digital Identities,” which is hereby incorporated by reference, can be used to apply and change skins used with the electronic notes as disclosed herein.

The above-described embodiments have generally been disclosed as a person-to-person application. However, the methods disclosed herein can be employed in a consumer-to-business application. In such an embodiment, a business can provide electronic notes to select consumers. These electronic notes can contain advertisements for special events, e.g., sales or extended store hours. These electronic notes can also contain bar codes that allow the business to scan the consumer's phone or PDA in order to give the consumer the sale price. Such notes can be expired at a predetermined point in time, e.g., at the time when the sale ends, or can be expired at a time later selected by the business, e.g., when the business runs out of stock of a the item referenced in the electronic note. Although the methods here have been described for use on computers, mobile telephones and PDAs, the invention is not so limited to operate only with these devices and it will be understood that the invention can operate on other devices.

Also, the invention may be embodied in a computer program product, as will now be explained.

On a practical level the software, that enables the computer system to perform the operations described in detail herein, may be supplied on any one of a variety of media. Furthermore, the actual implementation of the approach and operations of the invention are actually statements written in a computer language. Such computer language statements, when executed by a computer, cause the computer to act in accordance with the particular content of the statements. Furthermore, the software that enables a computer system to act in accordance with the invention may be provided in any number of forms including, but not limited to, original source code, assembly code, object code, machine language, compressed or encrypted versions of the foregoing, and any and all equivalents.

One of skill in the art will appreciate that “media”, or “computer-readable media”, as used here, may include a diskette, a tape, a compact disc, an integrated circuit, a ROM, a CD, a cartridge, a memory stick or card, a remote transmission via a communications circuit, or any other medium useable by computers, including those now known or hereafter developed. For example, to supply software for enabling a computer system to operate in accordance with the invention, the supplier might provide a disc or might transmit the software in some form via satellite transmission, via a direct telephone link, or via the Internet. Thus, the term, “computer readable medium” is intended to include all of the foregoing and any other medium by which software may be provided to a computer.

Although the enabling software might be “written on” a disc, “embodied in” an integrated circuit, “carried over” a communications circuit, “stored in” a memory chip, or “loaded in” a cache memory, it will be appreciated that, for the purposes of this application, the software will be referred to simply as being “in” or “on” the computer readable medium. Thus, the terms “in” or “on” are intended to encompass the above mentioned and all equivalent and possible ways in which software can be associated with a computer readable medium.

For the sake of simplicity, therefore, the term “computer program product” is thus used to refer to a computer readable medium, as defined above, which has on it any form of software to enable a computer system to operate according to any embodiment of the invention.

The foregoing embodiments and advantages are merely exemplary and are not to be construed as limiting the present invention. The description of the present invention is intended to be illustrative, and is not intended to limit the scope of the claims. Many alternatives, modifications, and variations will be apparent to those skilled in the art.

What is claimed is:

1. A computer-implemented method of controlling an electronic note, the method comprising:
creating the electronic note;
specifying one or more recipients of the electronic note, wherein a creator of the electronic note and each of the recipients have an electronic contract embodying an agreement to allow the recipient to access the electronic note;
specifying an expiration time for the electronic note, automatically causing the recipients' access to the electronic note to expire; and
changing the electronic note thereby causing the recipients to be notified of a change to the electronic note.

2. The method according to claim 1, wherein said changing the electronic note comprises providing the change to the electronic note to a source identity server associated with the creator, wherein the source identity server limits access to the changed electronic note based on identify information.

3. The method according to claim 2, wherein the electronic note relates to at least one of an event occurring at a specified time, an event occurring at a specified location, a travel itinerary, and a meeting notice.

4. The method according to claim 2, wherein the creator provides the changed information from a computer.

5. The method according to claim 2, wherein the creator provides the changed information from one of a mobile telephone and a personal digital assistant.

6. The method according to claim 1, wherein the electronic note is a unitary item of content that includes information comprised of one or more of text and graphics arranged in a layout according to a particularized style.

7. The method according to claim 1, wherein the electronic note is presented to the recipients by displaying the electronic note with the appearance of a self-stick note.

8. An apparatus for providing at least one recipient with access to an electronic note controlled by a source of the electronic note, wherein the recipient has an identity account on a recipient identity server and an agreement with the note source, embodied in an electronic contract, to access the electronic note, the apparatus comprising:
a receiving unit configured to receive and store the electronic note and changes to the electronic note;
a notification unit configured to send a note notification message to the recipient identity server indicating that the electronic note is available for access, in response to receiving the electronic note, and configured to send a change notification message to the recipient identify server in response to receiving the change to the electronic note; and
a note access unit configured to provide the recipient with access to the electronic note and the changed electronic note if the receiving unit has stored changes to the electronic note.

9. The apparatus according to claim 8, further comprising a note expiration unit configured to prevent access to the electronic note and the changes to the electronic note after an expiration time for the note has passed.

10. The apparatus according to claim 9, wherein the notification unit is configured to send note notification messages as Simple Object Access Protocol (SOAP) over Hypertext Transfer Protocol (HTTP) messages.

11. The apparatus according to claim 8, wherein the note access unit is configured to limit access to the changed electronic note to recipients having an agreement, embodied in an electronic contract, with the note source to access the electronic note.

12. The apparatus according to claim 8, wherein the note access unit is configured to prevent disclosure of identities of the recipients of the electronic note.

13. The apparatus according to claim 8, wherein the electronic note is a unitary item of content that includes information comprised of one or more of text and graphics arranged in a layout according to a particularized style.

14. The apparatus according to claim 8, wherein the electronic note is presented to the recipients by displaying the electronic note with the appearance of a self-stick note.

15. An apparatus for providing at least one recipient with access to an electronic note controlled by a note owner, wherein the note owner has an identity account on a source identity server and an agreement with the recipient, embodied in an electronic contract, to provide the recipient with access the electronic note, the apparatus comprising:
a notification unit configured to receive a change notification message from the source identify server indicating the electronic note has changed; and
a note access unit configured to access the electronic note in response to receiving the change notification message, thereby providing the recipient access to the changed electronic note and wherein the note owner retains control of the electronic note.

16. The apparatus according to claim 15, wherein the electronic note is a unitary item of content that includes information comprised of one or more of text and graphics arranged in a layout according to a particularized style.

17. A method of presenting a change to an electronic note accessible by a recipient, the method comprising:
the recipient of the electronic note receiving an automatic notification of a change to the electronic note, wherein the recipient has a contractual agreement with an owner of the electronic note to access the electronic note;
requesting access to the electronic note after receiving notification of the change to the electronic note; and
in response to requesting access to the electronic note, accessing the changed electronic note for presentation to the recipient.

18. The method according to claim 17, wherein an expiration time is associated with the electronic note, the method further comprising inhibiting the recipient's access to the electronic note and the changed electronic note if the expiration time has passed.

19. The method according to claim 18, wherein said recipient accesses the electronic note using a communication device, and said inhibiting the recipient's access to the electronic note if the expiration time has passed comprises:
receiving a list of one or more electronic notes having an expiration time that has not passed, in response to said requesting access to the electronic note; and
removing from the recipient's communication device electronic notes that are not included in said list.

20. The method according to claim 19, wherein said recipient's communication device is one of a computer, a mobile telephone, and a personal digital assistant.

21. The method according to claim 20, wherein the electronic note contains information that relates to at least one of an event occurring at a specified time, an event occurring at a specified time location, a travel itinerary, and a meeting notice.

22. A communications device comprising:
a message receiving unit configured to receive information based on a contractual relationship between a note source and a recipient, the information being associated with an expiration time, and configured to receive updated information;
a storage unit configured to store the information and the updated information;
an information presentation unit configured to present the information and the updated information as an electronic note; and
a control unit configured to remove the information and the updated information from the storage unit when the expiration time has passed.

23. The device according to claim 22, wherein the message receiving unit is further configured to:
receive notification that updated information is available; and
request the updated information, in response to receiving the notification.

24. The device according to claim 22, wherein the control unit is further configured to:
receive a list of unexpired electronic note information in response to the request for the electronic note information; and
remove any electronic note information that is not included in the list of unexpired electronic note information.

25. The method according to claim 22, wherein the device is at least one of a computer, mobile telephone, and personal digital assistant.

26. The method according to claim 22, wherein the information relates to at least one of an event occurring at a specified time, an event occurring at a specified time location, a travel itinerary, and a meeting notice.
